(19) United States
(12) Patent Application Publication
(10) Pub. No.: US 2009/0091270 A1
(43) Pub. Date: Apr. 9, 2009

(54) LIGHT SOURCE UNIT, A BACKLIGHT UNIT HAVING THE LIGHT SOURCE UNIT AND A LIQUID CRYSTAL DISPLAY HAVING THE BACKLIGHT UNIT

(76) Inventors: Woo-il Park, Yongin-si (KR); Seung-je Lee, Seongnam-si (KR); Seoung-bum Pyoun, Pyeongtaek-si (KR); Bum-jin Kim, Cheonan-si (KR); Dae-seop Kim, Anseong-si (KR)

Correspondence Address: F. CHAU & ASSOCIATES, LLC, 130 WOODBURY ROAD, WOODBURY, NY, 11797, US

(21) Appl. No.: 12/141,684

(22) Filed: Jun. 18, 2008

(30) Foreign Application Priority Data
Oct. 8, 2007 (KR) 10-2007-0100958

(51) Int. Cl. H05B 37/02

(52) U.S. Cl. 315/294

(57) ABSTRACT

A light source unit, including: at least one light source array having a plurality of light sources; a first resistive element connected in parallel to at least one of the light sources disposed at a first end of the light source array; and a second resistive element connected in parallel to at least one of the light sources disposed at a second end of the light source array.

### CROSS-REFERENCE TO RELATED APPLICATION

This application claims priority to Korean Patent Application No. 10-2007-0100958, filed on Oct. 8, 2007, in the Korean Intellectual Property Office, the disclosure of which is incorporated by reference herein in its entirety.

### BACKGROUND OF THE INVENTION

1. Technical Field

The present invention relates to a light source unit, a backlight unit having the light source unit and a liquid crystal display having the backlight unit, and more particularly, to a light source unit emitting uniform color at an edge thereof, a backlight unit having the light source unit, and a liquid crystal display having the backlight unit.

2. Discussion of the Related Art

A liquid crystal display (LCD) includes an LCD panel, which has an upper substrate with a black matrix, color filters and a common electrode formed thereon, a lower substrate with thin film transistors and pixel electrodes formed thereon, and a liquid crystal layer interposed between the two substrates. The LCD further includes polarizing plates adhering to both surfaces of the LCD panel.

The LCD displays an image by using a separate light source. In other words, the LCD does not emit light by itself. Therefore, the LCD includes a lighting unit such as a backlight unit for providing light to the LCD panel so that images can be displayed thereon.

A cold cathode fluorescent lamp (CCFL) has been used as a light source for the backlight unit. In some applications, the CCFL has been replaced with a light emitting diode (LED) which has characteristics such as long life, small size, light weight, strong light directivity, low power consumption, and the ability to withstand impacts and vibrations. Further, the LED does not require preheating time and utilizes simpler circuits, and it can be packaged into a variety of shapes.

A conventional LED light source unit includes three primary color LEDs, i.e., red, blue and green LEDs, to emit white light. To improve the quality of an output image, white light may be uniformly emitted by the light source unit. However, a conventional LED light source unit is configured such that all LEDs emit the same amount of light regardless of their positions. Therefore, white light, which has different wavelength bands, is emitted at an edge of the light source unit. For example, when a red LED is disposed at one end of a light source unit and a blue LED is disposed at the other end thereof, reddish white light is emitted at the one end of the light source unit and bluish white light is emitted at the other end thereof. Accordingly, non-uniform colors are emitted at an edge of a light source unit, thereby degrading the quality of an image output at an edge of an LCD panel.

Accordingly, there exists a need for a light source unit that is capable of preventing non-uniform color from being emitted at an edge thereof.

### SUMMARY OF THE INVENTION

According to an exemplary embodiment of the present invention, there is provided a light source unit for a backlight which includes at least one light source array having a plurality of light sources; a first resistive element connected in parallel to at least one of the light sources disposed at a first end of the light source array; and a second resistive element connected in parallel to at least one of the light sources disposed at a second end of the light source array.

The light sources may include red, green and blue light emitting diodes (LEDs).

The light sources may include LED packages each of which includes red, green and blue LEDs.

At least one of the plurality of LED packages may include more of the blue LEDs than the red or green LEDs.

At least one of the resistive elements may be formed integrally with or separately from at least one of the LED packages.

At least one of the resistive elements may be an active resistive element.

The active resistive element may be a diode.

At least one of the resistive elements may be a passive resistive element.

The passive resistive element may be a fixed resistor.

According to an exemplary embodiment of the present invention there is provided a backlight unit which includes a light source unit including at least one light source array having a plurality of light sources; a first active resistive element connected in parallel to at least one of the light sources disposed at a first end of the light source array; and a second active resistive element connected in parallel to at least one of the light sources disposed at a second end of the light source array.

The light sources may include red, green and blue LEDs.

The light sources may include LED packages each of which includes red, green and blue LEDs.

The active resistive elements may be diodes.

The backlight unit may further comprise a light guide plate, and the light source unit may be disposed at a lateral side of the light guide plate.

The backlight unit may further comprise a light guide plate, and the light source unit may be disposed under the light guide plate.

According to an exemplary embodiment of the present invention, there is provided a liquid crystal display (LCD), which includes an LCD panel for displaying an image; and a backlight unit for providing light to the LCD panel, wherein the backlight unit comprises: a light source unit including at least one light source array having a plurality of light sources; a first active resistive element connected in parallel to at least one of the light sources disposed at a first end of the light source array; and a second active resistive element connected in parallel to at least one of the light sources disposed at a second end of the light source array.

The light sources may include red, green and blue LEDs.

The light sources may include LED packages each of which has red, green and blue LEDs.

The active resistive elements may be diodes.

### BRIEF DESCRIPTION OF THE DRAWINGS

The above and other features of the present invention will become more apparent by describing in detail exemplary embodiments thereof with reference to the accompanying drawings in which:

FIG. 1 is an exploded perspective view of a liquid crystal display (LCD) according to an exemplary embodiment of the present invention;

FIG. 2 is a block diagram of a light source unit according to an exemplary embodiment of the present invention;

FIG. 3 is a circuit diagram of a light source unit according to an exemplary embodiment of the present invention;

FIG. 4 is a graph illustrating an operational characteristic of a diode according to an exemplary embodiment of the present invention; and

FIG. 5 is an exploded perspective view of an LCD according to an exemplary embodiment of the present invention.

### DETAILED DESCRIPTION OF EXEMPLARY EMBODIMENTS

Exemplary embodiments of the present invention will be described more fully hereinafter with reference to the accompanying drawings. This invention may, however, be embodied in many different forms and should not be construed as being limited to the embodiments set forth herein. Throughout the drawings, like reference numerals are used to designate like elements.

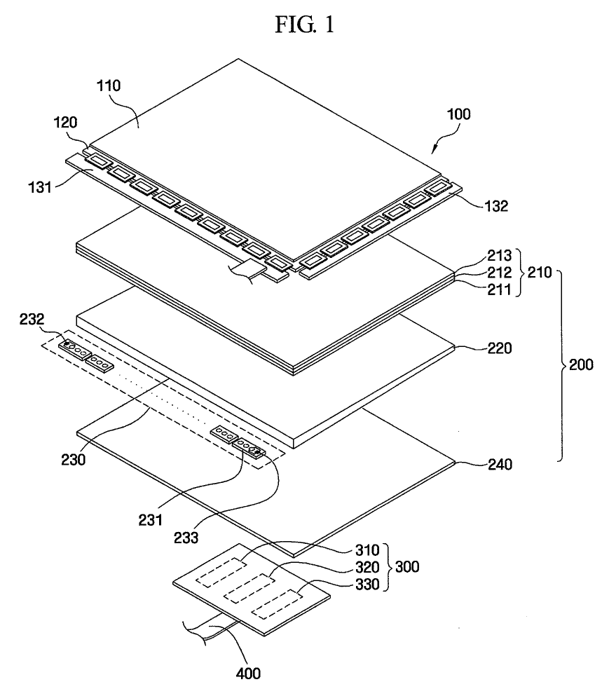

FIG. 1 is an exploded perspective view of a liquid crystal display (LCD) according to an exemplary embodiment of the present invention.

Referring to FIG. 1, the LCD according to this embodiment includes an LCD panel 100 for displaying images, a backlight unit 200 (210, 220, 230 and 240) disposed under the LCD panel 100, and a control printed circuit board (PCB) 300 for controlling the LCD panel 100 and the backlight unit 200.

The LCD panel 100 includes an upper substrate 110, a lower substrate 120 disposed to face the upper substrate 110, and a liquid crystal layer (not shown) interposed between the two substrates 110 and 120. In addition, the LCD panel 100 includes gate lines (not shown) extending in one direction, data lines (not shown) extending in the other direction to intersect the gate lines, and unit pixels (not shown) formed at regions where the gate and data lines intersect each other. A thin film transistor (TFT) and a liquid crystal capacitor Clc are provided in each of the unit pixels. A storage capacitor Cst may be additionally provided in each unit pixel. Here, the liquid crystal capacitor Clc is formed by interposing a liquid crystal layer as a dielectric between a pixel electrode and a common electrode facing each other. When the TFT is turned on, a data signal is charged into the liquid crystal capacitor Clc, so that the alignment of molecules in the liquid crystal layer can be controlled. The storage capacitor Cst is formed by interposing a protective layer as a dielectric between a pixel electrode and a storage electrode facing each other. The storage capacitor Cst stably maintains a data signal charged in the liquid crystal capacitor Clc until the next data signal is charged into the storage capacitor Cst. It will be apparent that the storage capacitor Cst as a subsidiary of the liquid crystal capacitor Clc may be omitted. Each of the unit pixels may uniquely display any one of three primary colors (i.e., red, green and blue). To this end, a color filter of any one of the three primary colors is provided in each unit pixel, and a black matrix for preventing light leakage is provided between the unit pixels.

Gate and data drivers 131 and 132 for driving the respective unit pixels may be provided outside of the aforementioned LCD panel 100. Here, the gate and data drivers 131 and 132 may be provided outside a pixel region in the LCD panel 100. For example, the gate and data drivers 131 and 132 may be directly formed on the lower substrate 120 of the LCD panel 100 using an amorphous silicon gate (ASG) technology, or may be separately manufactured to be mounted on the lower substrate 120 of the LCD panel 100 using a technology including chip on board (COB), tape automated bonding (TAB), chip on glass (COG) or the like. For example, the gate driver 131 according to this embodiment is manufactured in the form of a plurality of driving chips respectively connected to a plurality of gate lines, and mounted on the lower substrate 120. The gate and data drivers 131 and 132 are connected to the control PCB 300 through a flexible printed circuit (FPC) 400 or the like to receive predetermined electrical signals.

The backlight unit 200 is disposed under the LCD panel 100 to provide light to a rear surface of the LCD panel 100, so that a user can recognize an image displayed on the LCD panel 100. The backlight unit 200 according to this embodiment is an edge type and includes a light source unit 230 for emitting light, a light guide plate 220 disposed at a lateral side of the light source unit 230, a plurality of optical sheets 210 disposed over the light guide plate 220, and a reflective sheet 240 disposed under the light guide plate 220. Here, although the light source unit 230 is disposed at a lateral side of the light guide plate 220, the present invention is not limited thereto. For example, the light source unit 230 may be disposed at both lateral sides of the light guide plate 220.

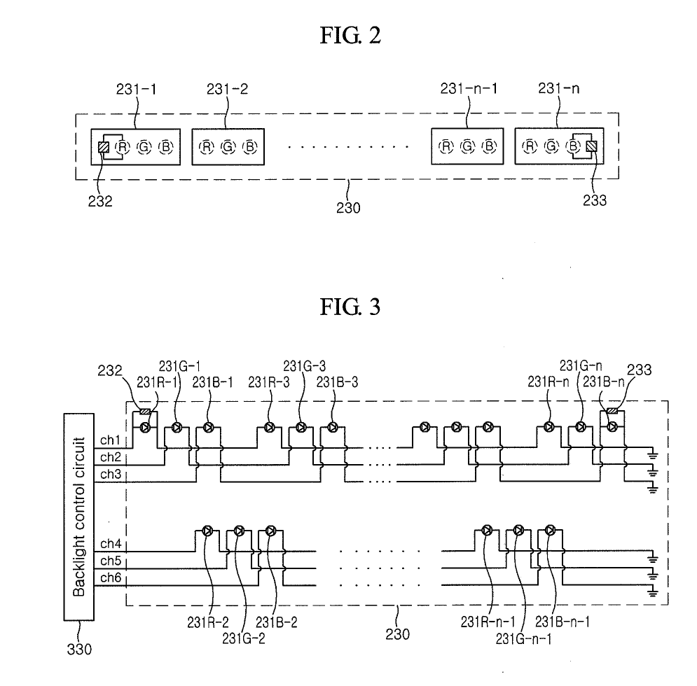

FIG. 2 is a block diagram of the light source unit according to an exemplary embodiment of the present invention, and FIG. 3 is a circuit diagram of a light source unit according to an exemplary embodiment of the present invention.

Referring to FIG. 2, the light source unit 230 includes at least one light source array having a plurality of light sources. The plurality of light sources may be arranged in a line, and a light emitting diode (LED) may be used as the light source. For example, the light source array may be configured to include red, green and blue LEDs R, G and B arranged in a line. Alternatively, the light source array may be configured such that LED packages 231-1 to 231-n each including red, green and blue LEDs R, G and B are arranged in a line as shown in this figure. At least one of the LED packages 231-1 to 231-n may include more blue LEDs B than red or green LEDs R or G. Here, for example, two or more blue LEDs B may be included to reinforce a blue light band which has a relatively insufficient amount of light.

Referring to FIG. 3, in a circuit view, the light source array of the light source unit 230 has a plurality of light source groups each of which includes a plurality of light sources connected in series. For example, the light source array according to this embodiment includes a first light source group having odd-numbered red LEDs 231R-1, 231R-3, 231R-n connected in series to one another, a second light source group having odd-numbered green LEDs 231G-1, 231G-3, . . . , 231G-n connected in series to one another, a third light source group having odd-numbered blue LEDs 231B-1, 231B-3, . . . , 231B-n connected in series to one another, a fourth light source group having even-numbered red LEDs 231R-2, 231R-4, . . . , 231R-n-1 connected in series to one another, a fifth light source group having even-numbered green LEDs 231G-2, 231G-4, . . . , 231G-n-1 connected in series to one another, and a sixth light source group having even-numbered blue LEDs 231B-2, 231B-4, . . . , 231B-n-1 connected in series to one another. The plurality of light source groups are connected to a plurality of driving channels ch1 to ch6 provided in a backlight control circuit 330 to thereby be independently driven. For example, the backlight control circuit 330 according to this embodiment includes the first and fourth driving channels ch1 and ch4 to which the first and fourth light source groups are respectively connected, the second and fifth driving channels ch2 and ch5 to which the second and fifth light source groups are respectively connected, and the third and sixth driving channels ch3 and ch6 to which the third and sixth light source groups are respectively connected. It will be apparent that the configuration of the light source groups and the driving channels ch1 to ch6 may vary depending on a desired objective. For example, in a case where a light source array includes m×n LEDs, in which m LEDs are connected in series to configure n light source groups, a backlight control circuit having n driving channels can be used. Here, m and n are integers of 1 or more.

The light source unit 230 according to this embodiment further includes resistive elements respectively connected in parallel to the light sources disposed at both ends of the light source array. For example, a first resistive element 232 is connected in parallel to the red LED 231R-1 disposed at one end of the light source array, and a second resistive element 233 is connected in parallel to the blue LED 231B-n disposed at the other end of the light source array. As shown in this figure, the first and second resistive elements 232 and 233 may be formed integrally with the LED packages 231-1 and 231-n, respectively. Alternatively, the first and second resistive elements 232 and 233 may be formed separately from the LED packages 231-1 and 231-n. The amount of light emitted from the LEDs 231R-1 and 231B-n disposed at both ends of the light source array is controlled to be relatively small by the resistive elements 232 and 233, so that the emission of non-uniform color at both end regions of the light source array can be prevented. For example, in a conventional LED light source, the wavelength band of specific light sources disposed at both ends of the light source unit is combined with white light, thereby causing non-uniform color to be emitted at both end regions of the light source unit. For example, reddish white light is made at one end region of a light source unit in which a red LED is disposed, and bluish white light is made at the other end region of the light source unit in which a blue LED is disposed. However, in the light source unit 230 according to this embodiment, the resistive elements 232 and 233 are respectively connected in parallel to the light sources disposed at both ends of the light source unit 230, i.e., the red and blue LEDs 231R-1 and 231B-n, to distribute current. Accordingly, the current applied to the light sources 231R-1 and 231B-n disposed at both ends of the light source unit 230 is relatively decreased. Therefore, the amount of light emitted from the light sources 231R-1 and 231B-n disposed at both ends of the light source unit 230 is reduced, so that uniform white light can be made and emitted at both end regions of the light source unit 230.

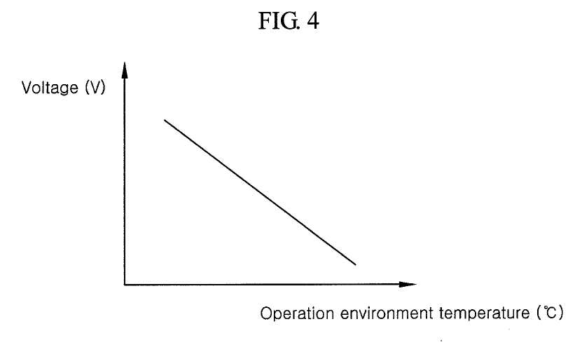

Active resistive elements such as diodes or passive resistive elements such as fixed resistors may be used as the resistive elements 232 and 233. In addition, various other resistive elements may be used. Particularly, if an active resistive element is used, the current flowing through an LED can be actively controlled depending on a temperature change in an operating environment, as will be described hereinafter with reference to FIG. 4.

FIG. 4 is a graph illustrating an operational characteristic of a diode according to an exemplary embodiment of the present invention. In detail, the graph shows that an operating voltage of the diode is changed when there is temperature change in an operating environment.

As shown in FIG. 4, internal resistance of a diode, which is used as an active resistive element, decreases as the operating environment temperature increases, thereby lowering the operating voltage applied across both ends of the diode. Further, the LED 231R-1 or 231B-n, which is used as the light source at one of the ends of the light source unit 230, also has an operational characteristic similar to that of the diode as shown in FIG. 4. Thus, if the diode and the LED 231R-1 or 231B-n are connected in parallel to each other, their operational characteristics are changed together when there is a temperature change. Therefore, the current flowing through the LED 231R-1 or 231B-n can be actively controlled depending on a temperature change in an operating environment. For example, resistance of a passive resistive element such as a fixed resistor is fixed regardless of a change in temperature, whereas the resistance of an LED 231R-1 or 231B-n is changed when there is a change in temperature. Therefore, if the current flowing through the LED 231R-1 or 231B-n is out of a predetermined target range, the passive resistive element may need to be changed. On the other hand, resistance of an active resistive element such as a diode is changed together with the resistance of the LED 231R-1 or 231B-n when there is a change in temperature, so that the current flowing through the LED 231R-1 or 231B-n is adjusted to be within the predetermined target range. In addition, the resistance of the active resistive element and LED 231R-1 or 231B-n is lowered as the operating temperature is increased, so that power consumption can be reduced and therefore the heat generated during operation can also be reduced.

Referring back to FIG. 1, the light guide plate 220 converts light incident from the light source unit 230, of which optical distribution is in a form of a point light source, into light of which optical distribution is in a form of a surface light source. A wedge type plate or a flat panel type plate may be used. A thickness of the wedge type plate decreases as it gets farther from a side facing the light source unit 230 towards the opposite side, whereas a thickness of the flat panel type plate is substantially constant. A light incident portion through which light is incident is formed in a lateral side surface of the light guide plate 220, a light emitting portion through which light is emitted is formed in an upper surface of the light guide plate 220, and a reflective portion that allows light incident through the light incident portion to be emitted through the light emitting portion is formed in a lower surface of the light guide plate 220. The reflective portion may have a cross section of a triangle, hemisphere or lens shape. The reflective portion may be configured with prism patterns arranged in parallel in one direction. It will be apparent that the reflective portion may be omitted if a reflective sheet 240 is disposed under the light guide plate 220 as illustrated in this embodiment. The light guide plate 220 may be formed of a transparent material having a certain refractive index, such as Poly Methy Methacrylate (PMMA), polyolefine, polycarbonate or the like.

Optical sheets 210 make the luminance distribution of light upwardly emitted from the light guide plate 220 uniform. The optical sheets 210 may include first, second and third optical sheets 211, 212 and 213 laminated from the bottom thereof. Here, the first optical sheet 211 has a dispersion pattern and thus allows light incident from the light guide plate 220 to be dispersed upward and diffused. The second and third optical sheets 212 and 213 have prism patterns formed to intersect each other on the lower surfaces thereof, by which incident light having an inclination angle from the first optical sheet 211 is aligned in a vertical direction. Therefore, light is concentrated towards the upward direction.

By the reflective sheet 240, light leaking below the light guide plate 220 is reflected back to the light guide plate 220, so that most of the light emitted from the light source unit 230 exits to an upper surface of the light guide plate 220 to thereby enhance the light efficiency. Further, the reflected amount of the incident light can be adjusted so that the entire light-exiting surface of the backlight unit 200 has a uniform luminance distribution. The reflective sheet 240 may be adhered to a bottom surface of a receiving member (not shown) for accommodating the backlight unit 200 by means of an adhesive. Furthermore, the reflective sheet 240 may be formed integrally with the bottom surface of the receiving member or the light guide plate 220.

The control PCB 300 may include a timing control circuit 310, a driving voltage generating circuit 320 and a backlight control circuit 330. The timing control circuit 310 processes image signals input from an external image controller (not shown) and control signals thereof to be suitable for operational conditions of the LCD panel 100. The timing control circuit 310 thereby generates internal image and control signals, and transmits them to the gate and data drivers 131 and 132. The driving voltage generating circuit 320 generates various types of driving powers required for driving the LCD panel 100 using external power input from an external power supply (not shown), and provides them to the gate and data drivers 131 and 132. The backlight control circuit 330 generates various types of driving powers required for driving the light source unit 230 using external power input from an external power supply (not shown), and provides them to the light source unit 230. The backlight control circuit 330 may further include a dimming control circuit (not shown) for actively controlling the brightness of the light source unit 230 according to the control of the timing control circuit 310.

Although an edge type backlight, in which a light source unit is disposed at a lower lateral side of an LCD panel, has been described in conjunction with the LCD of FIG. 1, the present invention is not limited thereto. For example, the present invention may be applied to LCD panels compatible with various structures, e.g., a direct type backlight in which a light source unit is disposed under an LCD panel. Hereinafter, an LCD which uses a direct type backlight will be described and descriptions overlapping with the aforementioned embodiment will be omitted or briefly described.

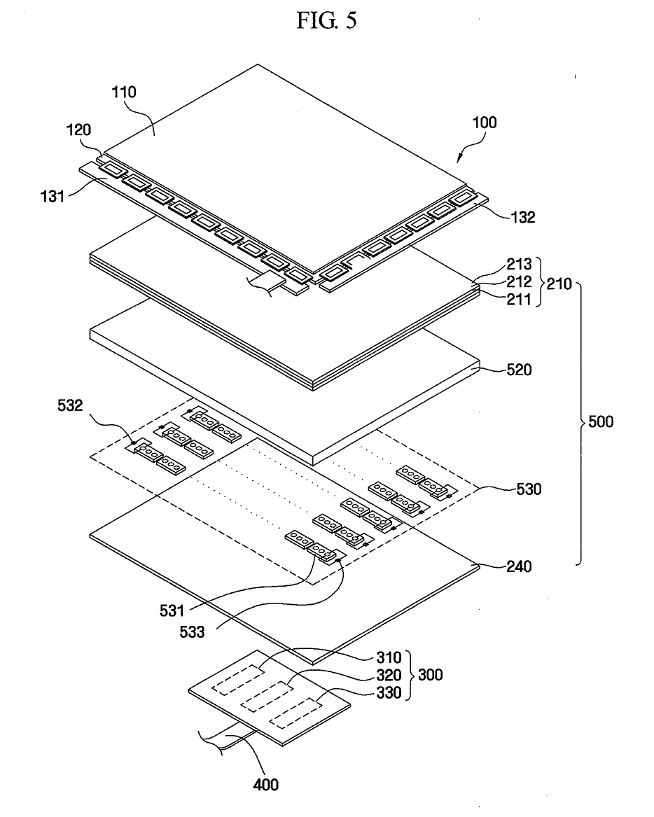

FIG. 5 is an exploded perspective view of an LCD according to an exemplary embodiment of the present invention.

Referring to FIG. 5, the LCD according to this embodiment includes an LCD panel 100 for displaying images, a backlight unit 500 (210, 520, 530 and 240) disposed under the LCD panel 100, and a control PCB 300 for controlling the LCD panel 100 and the backlight unit 500. The backlight unit 500 includes a light source unit 530 for emitting light, and a light guide plate 520 and optical sheets 210 which are disposed over the light source unit 530. The backlight unit 500 may further include a reflective sheet 240 disposed under the light source unit 530. Here, the light guide plate 520 may be omitted if necessary. As the light provided from the backlight unit 500 is transmitted through the LCD panel 100, transmittance of the light is changed and the light is colored, whereby a color image is displayed on a surface of the LCD panel 100.

The light source unit 530 includes a plurality of light source arrays spaced apart from one another by a predetermined interval. Each of the light source arrays may be configured by arranging a plurality of LED packages 531, each of which includes red, green and blue LEDs. Particularly, the light source unit 530 further includes resistive elements 532 and 533 connected in parallel to light sources disposed at both ends of each light source array. The resistive elements 532 and 533 control the amount of light emitted from the LEDs disposed at both ends of the light source unit 530 to be relatively small, thereby preventing non-uniform of color from being emitted at both end regions of the light source unit 530.

In the aforementioned embodiments, although resistive elements are connected only to the LEDs disposed at both ends of a light source unit, the present invention is not limited thereto. For example, the resistive elements may also be connected to LEDs disposed adjacent to both ends of the light source unit, and to LEDs disposed in an edge area of the light source unit.

According to an exemplary embodiment of the present invention, resistive elements are connected in parallel to light sources disposed at an edge of a light source unit to reduce the amount of light emitted from the light sources, thereby preventing non-uniform color from being generated at the edge of the light source unit. Therefore, degradation of the quality of an image output at the edge of an LCD panel can be prevented.

Further, according to an exemplary embodiment of the present invention, active resistive elements are connected in parallel to light sources disposed at an edge of a light source unit to actively control the amount of light emitted from the light source depending on a change in the temperature of an operating environment. Therefore, the emission of non-uniform color at the edge of the light source unit can be prevented regardless of a temperature change in the operating environment.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A light source unit for a backlight, comprising:
at least one light source array having a plurality of light sources;
a first active resistive element connected in parallel to at least one of the light sources disposed at a first end of the light source array; and
a second active resistive element connected in parallel to at least one of the light sources disposed at a second end of the light source array.

2. The light source unit as claimed in claim 1, wherein the light sources comprise red, green and blue light emitting diodes (LEDs).

3. The light source unit as claimed in claim 1, wherein the light sources comprise LED packages each of which includes red, green and blue LEDs.

4. The light source unit as claimed in claim 3, wherein at least one of the LED packages comprises more of the blue LEDs than the red or green LEDs.

5. The light source unit as claimed in claim 3, wherein at least one of the active resistive elements is formed integrally with at least one of the LED packages.

6. The light source unit as claimed in claim 3, wherein at least one of the active resistive elements is formed separately from at least one of the LED packages.

7. The light source unit as claimed in claim 1, wherein the first and second active resistive elements are a diode.

8. A backlight unit, comprising:
a light source unit including at least one light source array having a plurality of light sources;
a first active resistive element connected in parallel to at least one of the light sources disposed at a first end of the light source array; and
a second active resistive element connected in parallel to at least one of the light sources disposed at a second end of the light source array.

9. The backlight unit of claim 8, wherein the light sources comprise red, green and blue light emitting diodes (LEDs).

10. The backlight unit of claim 8, wherein the light sources comprise LED packages each of which includes red, green and blue LEDs.

11. The backlight unit of claim 8, wherein the active resistive elements are diodes.

12. The backlight unit of claim 8, further comprising:
a light guide plate, wherein the light source unit is disposed at a lateral side of the light guide plate.

13. The backlight unit of claim 8, further comprising:
a light guide plate, wherein the light source unit is disposed under the light guide plate.

14. A liquid crystal display (LCD), comprising:
an LCD panel for displaying an image; and
a backlight unit for providing light to the LCD panel,
wherein the backlight unit comprises:
a light source unit including at least one light source array having a plurality of light sources;
a first active resistive element connected in parallel to at least one of the light sources disposed at a first end of the light source array; and
a second active resistive element connected in parallel to at least one of the light sources disposed at a second end of the light source array.

15. The LCD as claimed in claim 14, wherein the light sources comprise red, green and blue light emitting diodes (LEDs).

16. The LCD as claimed in claim 14, wherein the light sources comprise LED packages each of which includes red, green and blue LEDs.

17. The LCD as claimed in claim 14, wherein the active resistive elements are diodes.
